(19) United States
(12) Patent Application Publication
(10) Pub. No.: US 2021/0267017 A1
(43) Pub. Date: Aug. 26, 2021

(54) Electric Heating Device

(71) Applicant: Eberpächer catem Hermsdorf GmbH & Co. KG, Hermdorf (DE)

(72) Inventors: Yves Knüpfer, Caaschwitz (DE); Andreas Kümpel, Wünschendof/Elster (DE)

(21) Appl. No.: 17/179,980

(22) Filed: Feb. 19, 2021

(30) Foreign Application Priority Data
Feb. 20, 2020 (DE) 10 2020 202 195.3

(51) Int. Cl. H05B 3/52; H05B 3/28

(52) U.S. Cl. CPC H05B 3/52; H05B 2203/023; H05B 2203/02; H05B 3/283

(57) ABSTRACT

An electric heating device includes at least one PTC element, conductor tracks electrically connected to the PTC element for energizing the PTC element, and insulating layers abutting in a thermally conductive manner against the PTC element. At least one of the insulating layers comprises at least one duct for the passage of a fluid to be heated.

### BACKGROUND OF THE INVENTION

### 1. Field of the Invention

The present invention relates to an electric heating device with at least one PTC element, conductor tracks electrically connected to the PTC element for energizing the PTC element, and insulating layers abutting in a thermally conductive manner against the PTC element.

### 2. Background of the Invention

Such electric heating devices are used, for example, in electric auxiliary heaters for heating a vehicle interior of a motor vehicle application. The heat generated by the electric heating device is typically transferred to an air flow via radiator elements abutting against the electric heating device in a thermally conductive manner or to the liquid medium, which heats an air flow by way of a heating ribs around which liquid medium flows in a heating chamber, and which heats an air flow by way of a heat exchanger, where the heated air flow is directed into the vehicle interior.

These concepts for heating a vehicle interior are known inter alia from EP 1 318 694 A1 and EP 1 872 986 A1.

### SUMMARY

The present invention seeks to provide an improved electric heating device. The present invention seeks in particular to improve heat transfer to a fluid that is to be heated. The fluid is typically a liquid.

To satisfy this object, the present invention proposes an electric heating device that includes at least one PTC element, conductor tracks electrically connected to the PTC element for energizing the PTC element, and insulating layers abutting against the PTC element in a thermally conductive manner. At least one of the insulating layers comprises at least one duct for passing a fluid to be heated.

The insulation layers generally abut in a thermally conductive manner against oppositely disposed main side surfaces of the PTC element. The insulating layers typically abut directly against the oppositely disposed main side surfaces of the PTC element, where the conductor tracks are typically applied as an electrically conductive layer to the main side surfaces of the PTC element. The electrically conductive layer can just as well be applied to the surfaces of the insulating layers abutting against the main side surfaces of the PTC element. The electrically conductive layer can be applied in a galvanic process, as described in DE 10 2006 033 691 A1. It can also be applied by sputtering, vapor deposition, or as a metal paste and be baked in. A combination of these methods for creating an electrically conductive layer is also possible. Alternatively, the insulating layers can also abut against the oppositely disposed main side surfaces of the PTC element with an electrically conductive contact plate disposed in between. Generally, the insulating layers are substantially plate-shaped electrical insulators made of ceramic material.

Since the fluid to be heated is passed through at least one duct of the insulating layer, the separation layers in the heat conduction path between the PTC element and the fluid to be heated can be reduced. Since the duct runs in the interior of the insulating layer, electrical insulation from the current-carrying layer and the PTC element is given at the same time. The heat transfer to the fluid to be heated can therefore be improved and material costs can be reduced by saving separation layers.

The insulating layer comprising the duct typically has a thickness of less than 10 mm.

In this respect, the electric heating device is particularly suitable for integration into a fluid circuit of a motor vehicle, for example, for heating the vehicle interior or for heating functional components such as a battery or a fuel cell. In these applications, the fluid to be heated is typically water.

The conversion of electrical energy from the vehicle's electrical system into heat is generally done in a PTC (Positive Temperature Coefficient) element. A PTC element is a semiconductor made of ceramic. The electric resistance of a PTC element is strongly dependent on the temperature. It conducts electricity better at low temperatures than at high temperatures. This means that the resistance of the PTC element increases with increasing temperature. This means that a uniform surface temperature arises at the PTC element regardless of the ancillary conditions—such as e.g. the voltage applied. Overheating is prevented at the same time. In this context, this is referred to as a self-regulating property of the PTC element.

A PTC element is typically cuboid or plate-shaped. This means that the PTC element is typically a body that is defined by six substantially rectangular side surfaces, where the six side surfaces are typically standing at right angles upon one another This body typically has twelve edges, four of which have the same lengths and are parallel to one another, where oppositely disposed side surfaces are congruent The two largest oppositely disposed side surfaces are called main side surfaces and the remaining four side surfaces connecting the main side surfaces to one another are called face sides. The extension of the body is generally greatest in one of the three spatial directions. The extension in this direction is called the length of the body. The extension of the body in the other two spatial directions is called width and height, respectively. The width of a plate-shaped PTC element is greater than the height, i.e. the main side surfaces are spanned by the vector of the body in the length direction and the vector of the body in the width direction.

For electrically contacting the PTC element, contact strips are typically attached to the insulating layers, such as being soldered on or adhesively bonded thereto. Alternatively, contact strips protruding beyond the insulating layers in one direction can be formed by the contact plates.

According to a preferred development of the present invention, the duct may be produced by dry pressing or extruding a raw mass containing ceramic powder and forming the starting material for the insulating layer, where the duct is given its final shape or final diameter by subsequent sintering of the pressed raw mass which generally comprises ceramic material. According to this development, the insulating layer comprising the duct is therefore a semi-finished product which is produced by dry pressing or extrusion and subsequent sintering. Alternatively, the duct can also be formed by a bore in the insulating layer. The ceramic powder is typically aluminum oxide powder. It generally forms the raw mass by being mixed with an organic binder and liquid.

The duct runs in the interior of the insulating layer. The inlet or outlet opening, respectively, of the duct is typically provided on a face side of the insulating layer.

In this way, the production of the insulating layer comprising the duct can be made as simple and inexpensive as possible.

According to a further preferred development of the present invention, the duct may extend substantially over the entire length extension of the PTC element and possibly over the entire length extension of the insulating layer. In other words, the length of the duct may correspond substantially to at least the length of the PTC element and even to the length of the insulating layer.

The heat generated is thus dissipated to the fluid substantially over the entire length of the PTC element. Furthermore, passing the fluid into and out of the insulating layer is simplified if the duct extends over the entire length of the insulating layer.

According to a further preferred development of the present invention, sides of the insulating layers facing away from the PTC element may form externally exposed surfaces of the electric heating device. In other words, an outer side of the electric heating device may be formed at least in sections by sides of the insulating layers facing away from the PTC element. The electric heating device may be exposed with this outer side to the environment, i.e. to the air or a fluid to be heated.

The electric heating device according to this preferred development may be characterized by a compact design, so that the electric heating device can be used in a space-saving manner.

According to a further preferred development of the present invention, at least one respective insulating layer with at least one duct may be provided on opposed main side sides of the PTC element. In this way, heat can be dissipated via both main side surfaces of the PTC element to the fluid to be heated. In particular, the insulating layers typically have a multitude or a plurality of such ducts, which are typically arranged parallel to one another. In this respect, the insulating layers may be penetrated by a plurality of ducts. The heat transfer to the fluid to be heated can be increased in this way. With this development, fluids from at least two different fluid circuits, into each of which one of the insulating layers is integrated, can be heated or a fluid from a single fluid circuit that is divided between the respective insulating layers and merged again downstream.

According to a further preferred development of the present invention, the electric heating device may have a device for resiliently pretensioning the insulating layers against the PTC element. The device for resiliently pretensioning can be formed by a spring which presses from the outside onto one of the insulating layers and which is supported on a housing of the electric heating device, and/or a clamp engaging around the insulating layers.

This prevents an air gap from forming in the heat conduction path between the insulating layers and the PTC element, which would reduce heat transfer.

According to a further preferred development of the present invention, the electric heating device may have an electrically insulating mass that completely seals the PTC heating element circumferentially, as is known, for example, from EP 3 101 998 A1. The mass can be applied as an adhesive bead or in an injection molding process in the region of an edge formed by the abutment of the insulating layer against the PTC element. The mass may be in contact with both insulating layers, so that the PTC element is completely encapsulated in all directions by electrically insulating material due to the combination of insulating layers and electrically insulating mass, while only the contact strips are passed through the encapsulation.

This electrically insulating mass typically comprises a silicone mass as the liquid phase. The liquid phase may be formed by addition-crosslinking 2-component silicone that cures at room temperature and cures in an accelerated manner when subject to heat. The mass typically has a viscosity at 25° C. of between 100 and 200 Pa s. With regard to good flowability, gasoline or toluene is typically added to the 2-component silicone as a thinner to obtain a viscosity at 25° C. in a range of between 4 and 15, more typically between 5 and 8 Pa s. The thermal conductivity of the mass (liquid phase+particles) is regularly between 3.0 and 5.0 W/(m K). In the crosslinked state, the component of the mass forming the liquid phase should have a Shore A hardness of about 10-40 and a dielectric strength CTI>600. A predetermined content of solids with high thermal conductivity is typically added to this liquid phase. The thermal conductivity of the filler component should be between 20 and 30 W(m K). The filler may be aluminum oxide. With regard to good flow properties, spherical aluminum oxide with an average grain size of approx. 4 to 6 mm is preferred. With regard to good thermal conductivity of the mass (liquid phase+filler content), the mass may have a filler content of at least 50% by volume, and more typically between 85 and 95% by volume.

With this electrically insulating encapsulation, the electric heating device is particularly suitable for use in high-voltage applications. This is because, particularly in high-voltage applications, for example when installing the PTC heating device in an electric heating device for an electrically driven motor vehicle, electrical flashovers, for example, due to air and/or creepage distances, must be avoided.

### BRIEF DESCRIPTION OF THE DRAWINGS

Further details and advantages of the present invention shall become apparent from the following description of an embodiment in combination with the drawing, in which:

FIG. 1 shows an exploded view of an electric heating device according to the embodiment,

FIG. 2 shows a sectional view based on section line A in FIG. 1, and

FIG. 3 is a schematic representation of the embodiment.

### DETAILED DESCRIPTION

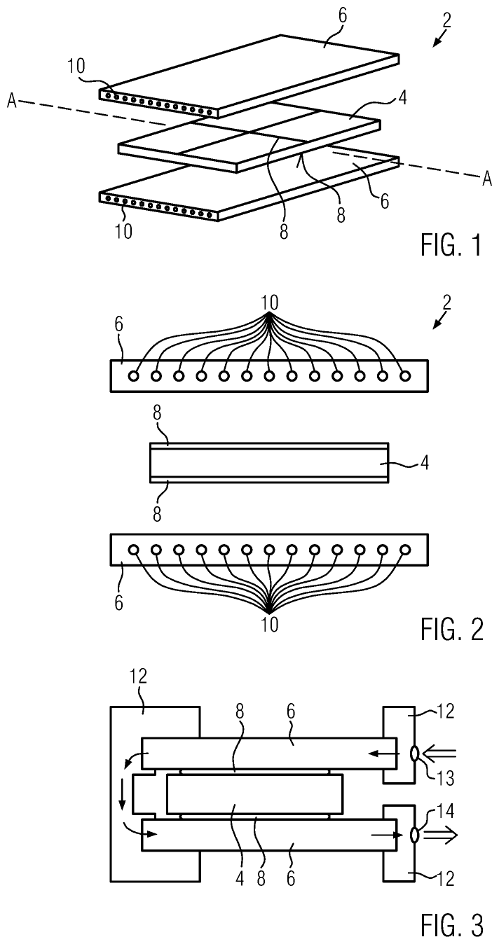

FIG. 1 shows an electric heating device 2 with a plate-shaped PTC element 4 which is arranged between two plate-shaped insulating layers 6. An electrically conductive layer 8 is applied to each of the two main side surfaces of the PTC element 4. The layer 8 is presently applied over the entire surface. The insulating layers 6 are clamped together by a pretensioning element (not shown) with the PTC element 4 in between to form a sandwiched arrangement.

The insulating layers 6 are each a semi-finished product that is produced by extruding a raw mass containing ceramic powder and subsequent sintering. The insulating layers 6 are electrically insulating and penetrated in the length direction by ducts 10 for passing a fluid to be heated, where the ducts were produced in the course of the extrusion process and given their final diameter by sintering. Since the ducts run in the interior of the insulating layer 6, the fluid is electrically insulated from the current-carrying layer 8 and the PTC element 4 by the material of the insulating layers 6 surrounding the ducts 10. The openings of the ducts 10 are formed on the face sides of the insulating layers. Contact strips (not shown) are soldered onto the electrical layers 8 for the electrical contact of the PTC element 4.

The face sides of the PTC element 4, which connect the two oppositely disposed main side surfaces of the PTC element 4 to one another, may be completely sealed circumferentially with electrically insulating silicone mass. Only the contact strips are passed through the silicone mass.

FIG. 2 shows a sectional view according to section line A from FIG. 1 and again illustrates that the ducts 10 penetrate the insulating layers 8 in the length direction.

Fluid distributor strips 12 made of plastic material are adhesively bonded onto the ends of the insulating layers 8 at the length side and are thereby connected to the insulating layers 8 in a fluid-tight manner (see FIG. 3). Two of the fluid distributor strips 12 form an inlet and outlet opening 13, 14, respectively, for supplying and respectively discharging a fluid to be heated, where, for example, a hose is connectable to the inlet and outlet opening 13, 14, respectively. These two fluid distributor strips 12 are provided on the same side but on different insulating layers 8. The fluid is passed into and respectively out of the openings of the ducts by way of the distributor strips 12. A third distributor strip 12 is formed having a U-shape and connects the openings of the ducts 10 of the two insulating layers 8 to one another on the oppositely disposed side. The U-shaped distributor strip 12 can exert a certain resilient pretension upon the insulating layers and thereby implement a device for pretensioning according to claim 6. The other two distributor strips 12 can be connected to a spring and thereby also implement a device for pretensioning according to claim 6.

1. An electric heating device comprising:
at least one PTC element;
conductor tracks electrically connected to the PTC element for energizing the PTC element; and
insulating layers abutting against the PTC element in a thermally conductive manner, wherein at least one of the insulating layers comprises at least one duct for passing a fluid to be heated therethrough.

2. The electric heating device according to claim 1, wherein the duct is formed by dry pressing or extruding the insulating layer.

3. The electric heating device according to claim 1, wherein the duct extends substantially over an entire length extension of the PTC element.

4. The electric heating device according to claim 1, wherein sides of the insulating layers facing away from the PTC element form externally exposed surfaces of the electric heating device.

5. The electric heating device according to claim 1, wherein the insulating layer with the at least one duct is formed by a uniform ceramic plate.

6. The electric heating device according to claim 1, wherein at least one respective insulating layer with at least one duct is provided on opposed sides of the PTC element.

7. The electric heating device according to claim 1, further comprising a device for resiliently pretensioning the insulating layers against the PTC element.

8. The electric heating device according to claim 1, further comprising an electrically insulating mass fully sealing the PTC element circumferentially.

9. The electric heating device according to claim 1, further comprising fluid distributor strips which are attached in a fluid-tight manner to ends of the insulating layer on a length side thereof and which are in communication with at least one opening of the at least one duct.

10. The electric heating device according to claim 9, wherein the fluid distributor strips are made of a plastic material.
